(19) United States
(12) Patent Application Publication
(10) Pub. No.: US 2024/0054817 A1
(43) Pub. Date: Feb. 15, 2024

(54) AUGMENTED VISUAL ASSESSMENT OF LAMENESS IN ANIMALS

(71) Applicants: Daniel W. CARTER, LaGrange, KY (US); Emily L. HALSMER, Ewing, VA (US)

(72) Inventors: Daniel W. CARTER, LaGrange, KY (US); Emily L. HALSMER, Ewing, VA (US)

(21) Appl. No.: 18/232,476

(22) Filed: Aug. 10, 2023

Related U.S. Application Data
(60) Provisional application No. 63/396,735, filed on Aug. 10, 2022.

(51) Int. Cl. G06V 40/20; G06V 10/82

(52) U.S. Cl. CPC G06V 40/25; G06V 10/82

(57) ABSTRACT

The present disclosure provides an augmented visual assessment system and methods of using the system for identification of a disorder in animals. In particular, the present disclosure provides an AVA (Augmented Visual Assessment) with CCS (Computed Core Symmetry) that allows practitioners to objectively gather, measure, assess and share data on gait asymmetry (e.g., lameness) and impaired motor movement of animals.

### CROSS-REFERENCE TO RELATED APPLICATIONS

This application claims the benefit under 35 U.S.C. § 119(e) of U.S. Provisional Application Ser. No. 63/396,735, filed on Aug. 10, 2022, the entire disclosure of which is incorporated herein by reference.

### TECHNICAL FIELD

The invention relates to systems and methods for evaluating disorders in animals, for instance lameness.

### BACKGROUND AND SUMMARY OF THE INVENTION

The current standard of care for medical professionals evaluating movement of animals includes a physical examination. Identification of abnormal movement suggests further investigation and/or referral to the appropriate specialty (such as neurology or orthopedics) for further evaluation. However, the examining medical professions inherently possesses limitations including but not limited to visual acuity, memory and bias from previous examinations, environmental distractions and crowded examination schedules, emotional status and limited expertise. As a result, animals are often inadequately evaluated, thus resulting in an inaccurate subjective evaluation. Unfortunately, such subjective evaluation leads to disagreement among medical professionals, resulting in missed opportunities for early intervention and optimal treatment.

Accordingly, there exists a need to develop technology in order to provide objective approaches to examination. However, availability of current technology is limited because of its expense and a time restraints. In particular, current technologies for objective gait evaluation of animals is affordable only for veterinarians who perform multiple gait assessments daily and is of little use to primary care providers.

Therefore, the present disclosure provides an Augmented Visual Assessment (AVA) system and methods thereof. The disclosed systems and methods offer an affordable, mobile, video-based diagnostic tool that is designed to aid medical professionals in evaluating movement and gait abnormalities in animals.

As described herein, AVA comprises a combination of advanced mechanics, optics, computer vision and artificial intelligence (AI) techniques. The systems and methods described herein provide several advantages compared to the state of the art. First, the system can identify subtle gait deficits that can allow early intervention to improve health care. Second, evaluation bias can be minimized by creating an electronic patient medical record. Unlike currently available commercial products used to objectively evaluate gait, no additional training is required to use the system and it can be used to augment current visual lameness evaluation techniques taught at veterinary medical schools.

Third, data can be collected during the evaluation trial without need for additional computer programs and data processing outside of the application. For instance, using AVA technology, equine veterinarians can be able to visually assess patients with a hands-off approach. This innovation greatly impacts gait evaluation by improving routine equine lameness examination performed daily in the horse racing industry.

Fourth, the system can be used to provide early recognition of lameness in food animals, which is economically important because dairy and beef cattle productivity is shown to increase substantially when cattle are free of orthopedic pain. Fifth, the system can provide a precision of gait evaluation tailored to animal industries in order to enhance early disease detection, focused treatments and improved outcomes, ultimately resulting in healthier subjects and improved profits. Sixth, the system can offer a medical record library that can allow file sharing among medical providers. Stored data concerning metrics, treatments, response, time stamps and progress notes can be reviewed and shared.

Seventh, for companion animals, early lameness detection for pet dogs and cats can provide opportunity for early intervention and improved animal comfort. Pets and their owners may not feel comfortable with examination of gait using wireless inertial body-mounted sensor techniques as it stresses the animals. Video marker tracking is tedious and results are not immediately available. Body mounted sensors cannot be applied to cats due to their small size and intolerant demeanor. The present disclosure overcomes these problems.

Finally, no existing mobile applications currently exist that objectively aid visual lameness detection. Existing equine electronic applications are limited to written records of financial, patient and client management. Although some mobile applications can evaluate human sport activities to provide visual analysis functionality, these applications (e.g., Ubersense, Coach's Eye, Dartfish Express) do not recognize or analyze symmetry of motion. Additionally, these applications lack the required spatial joint estimation accuracy for a reliable lameness assessment.

The following numbered embodiments are contemplated and are non-limiting:
1. An augmented visual assessment system comprising a first camera and a neural network system wherein the system is configured for motion capture of an animal.
2. The augmented visual assessment system of clause 1 wherein the neural network system is a computer.
3. The augmented visual assessment system of any of the preceding clauses wherein the first camera comprises a parfocal lens of at least a 4-250 mm focal length.
4. The augmented visual assessment system of any of the preceding clauses wherein the second camera comprises a motorized parfocal lens.
5. The augmented visual assessment system of any of the preceding clauses wherein the system captures slow-motion performance of the animal.
6. The augmented visual assessment system of any of the preceding clauses wherein the system is capable of capturing video at 60 frames or greater per second.
7. The augmented visual assessment system of any of the preceding clauses wherein the system is capable of capturing video at 120 frames or greater per second.
8. The augmented visual assessment system of any of the preceding clauses wherein the system comprises a steady automatic zoom feature.
9. The augmented visual assessment system of any of the preceding clauses wherein the system is configured for motion tracking of the animal.
10. The augmented visual assessment system of any of the preceding clauses wherein the system is configured to track movement of an anatomical structure of the animal.
11. The augmented visual assessment system of any of the preceding clauses wherein the system is configured to evaluate vertical displacement of an anatomical structure of the animal.
12. The augmented visual assessment system of any of the preceding clauses wherein the system is configured to evaluate velocity of an anatomical structure of the animal.
13. The augmented visual assessment system of any of the preceding clauses wherein the system is configured to evaluate acceleration of an anatomical structure of the animal.
14. The augmented visual assessment system of any of the preceding clauses wherein the system is configured to evaluate position of an anatomical structure of the animal.
15. The augmented visual assessment system of any of the preceding clauses wherein the system is configured to evaluate joint angle of an anatomical structure of the animal.
16. The augmented visual assessment system of any of the preceding clauses wherein the system is configured for gait analysis of the animal.
17. The augmented visual assessment system of any of the preceding clauses wherein the system is configured for three dimensional position estimate of an animal.
18. The augmented visual assessment system of any of the preceding clauses wherein the system is configured for controlling motorized gimbal.
19. The augmented visual assessment system of any of the preceding clauses wherein the system is configured for controlling motorized zoom.
20. The augmented visual assessment system of any of the preceding clauses wherein the system comprises a contrast adjustment.
21. The augmented visual assessment system of any of the preceding clauses wherein the system comprises a brightness adjustment.
22. The augmented visual assessment system of any of the preceding clauses wherein the system comprises a slow motion evaluation feature.
23. The augmented visual assessment system of any of the preceding clauses wherein the system comprises a side-by-side analysis feature.
24. The augmented visual assessment system of any of the preceding clauses wherein the system comprises a video library feature.
25. The augmented visual assessment system of any of the preceding clauses wherein the system comprises a time stamped record feature.
26. The augmented visual assessment system of any of the preceding clauses wherein the first camera comprises a motorized zoom feature.
27. The augmented visual assessment system of any of the preceding clauses wherein the animal is a member of the Equidae family.
28. The augmented visual assessment system of any of the preceding clauses wherein the animal is a horse.
29. The augmented visual assessment system of any of the preceding clauses wherein the animal is a donkey.
30. The augmented visual assessment system of any of the preceding clauses wherein the animal is a zebra.
31. The augmented visual assessment system of any of the preceding clauses wherein the animal is a bovine.
32. The augmented visual assessment system of any of the preceding clauses wherein the animal is a beef cattle.
33. The augmented visual assessment system of any of the preceding clauses wherein the animal is a dairy cattle.
34. The augmented visual assessment system of any of the preceding clauses wherein the animal is a porcine.
35. The augmented visual assessment system of any of the preceding clauses further comprising a second camera.
36. The augmented visual assessment system of clause 35 wherein the second camera comprises a motorized zoom feature.
37. The augmented visual assessment system of clause 35 wherein the second camera comprises a parfocal lens of at least a 4-250 mm focal length 38. The augmented visual assessment system of clause 35 wherein the second camera comprises a motorized parfocal lens.
39. The augmented visual assessment system of any of the preceding clauses wherein the system is configured for an application in a mobile device.
40. The augmented visual assessment system of clause 8 wherein the steady automatic zoom feature is configured for a constant scale.
41. The augmented visual assessment system of any of the preceding clauses wherein the system comprises fewer than 6 cameras, fewer than 5 cameras, fewer than 4 cameras, or fewer than 3 cameras.
42. The augmented visual assessment system of any of the preceding clauses wherein the system does not comprise a battery.
43. The augmented visual assessment system of any of the preceding clauses wherein the system provides substantially similar resolution on both the vertical plane dimension and the horizontal plane dimension.
44. The augmented visual assessment system of any of the preceding clauses wherein the system is non-invasive to the animal.
45. The augmented visual assessment system of any of the preceding clauses wherein the system comprises a video processor.
46. The augmented visual assessment system of clause 45 wherein the video processor is configured to receive video frames from the first camera and from the second camera at over 100 fps.
47. The augmented visual assessment system of clause 46 wherein the video processor is configured to synchronize video frames from the first camera and from the second camera using a timestamp.
48. The augmented visual assessment system of clause 46 wherein the video processor is configured to perform real-time motion analysis on the video frames.
49. The augmented visual assessment system of any of the preceding clauses wherein the system comprises an artificial intelligence configuration.
50. A method for diagnosing a disorder in an animal, said method comprising the step of using the augmented visual assessment system of any of the preceding clauses in diagnosis of the disorder in the animal.
51. The method of clause 50, wherein the disorder is lameness.
52. The method of clause 50, wherein the disorder is abnormal joint position of the animal.
53. The method of clause 50, wherein the disorder is abnormal gait of the animal.
54. The method of clause 50, wherein the disorder is a gait-related disorder of the animal.
55. The method of any of the preceding clauses, wherein the method is performed in the field.
56. The method of any of the preceding clauses, wherein the animal is a member of the Equidae family.
57. The method of any of the preceding clauses, wherein the animal is an equine.
58. The method of any of the preceding clauses wherein the animal is a horse.
59. The method of any of the preceding clauses wherein the animal is a donkey.
60. The method of any of the preceding clauses wherein the animal is a zebra.
61. The method of any of the preceding clauses wherein the animal is a bovine.
62. The method of any of the preceding clauses wherein the animal is a beef cattle.
63. The method of any of the preceding clauses wherein the animal is a dairy cattle.
64. The method of any of the preceding clauses wherein the animal is a porcine.

### DETAILED DESCRIPTION

In an illustrative aspect, an augmented visual assessment system is provided. The system comprises a first camera and a neural network system wherein the system is configured for motion capture of an animal.

In an embodiment, the neural network system is a computer. In an embodiment, the first camera comprises a parfocal lens of at least a 4-250 mm focal length. In an embodiment, the second camera comprises a motorized parfocal lens. In an embodiment, the system captures slow-motion performance of the animal. In an embodiment, the system is capable of capturing video at 60 frames or greater per second. In an embodiment, the system is capable of capturing video at 120 frames or greater per second.

In an embodiment, the system comprises a steady automatic zoom feature. In an embodiment, the system is configured for motion tracking of the animal. In an embodiment, the system is configured to track movement of an anatomical structure of the animal. In an embodiment, the system is configured to evaluate vertical displacement of an anatomical structure of the animal. In an embodiment, system is configured to evaluate velocity of an anatomical structure of the animal. In an embodiment, the system is configured to evaluate acceleration of an anatomical structure of the animal. In an embodiment, the system is configured to evaluate position of an anatomical structure of the animal. In an embodiment, the system is configured to evaluate joint angle of an anatomical structure of the animal. In an embodiment, the system is configured for gait analysis of the animal. In an embodiment, the system is configured for three dimensional position estimate of an animal.

In an embodiment, the system is configured for controlling motorized gimbal. In an embodiment, the system is configured for controlling motorized zoom. In an embodiment, the system comprises a contrast adjustment. In an embodiment, the system comprises a brightness adjustment. In an embodiment, the system comprises a slow motion evaluation feature. In an embodiment, the system comprises a side-by-side analysis feature.

In an embodiment, the system comprises a video library feature. In an embodiment, the system comprises a time stamped record feature. In an embodiment, the first camera comprises a motorized zoom feature.

In an embodiment, the animal is a member of the Equidae family. In an embodiment, the animal is an equine. In an embodiment, the animal is a horse. In an embodiment, the animal is a donkey. In an embodiment, the animal is a zebra.

In an embodiment, the animal is a bovine. In an embodiment, the animal is a beef cattle. In an embodiment, the animal is a dairy cattle.

In an embodiment, the animal is a porcine.

In an embodiment, the augmented visual assessment system further comprises a second camera. In an embodiment, the second camera comprises a motorized zoom feature. In an embodiment, the second camera comprises a parfocal lens of at least a 4-250 mm focal length. In an embodiment, the second camera comprises a motorized parfocal lens.

In an embodiment, the system is configured for an application in a mobile device. In an embodiment, the steady automatic zoom feature is configured for a constant scale. In an embodiment, the system comprises fewer than 6 cameras, fewer than 5 cameras, fewer than 4 cameras, or fewer than 3 cameras. In an embodiment, the system does not comprise a battery.

In an embodiment, the system provides substantially similar resolution on both the vertical plane dimension and the horizontal plane dimension. In an embodiment, the system is non-invasive to the animal.

In an embodiment, the system comprises a video processor. In an embodiment, the video processor is configured to receive video frames from the first camera and from the second camera at over 100 fps. In an embodiment, the video processor is configured to synchronize video frames from the first camera and from the second camera using a timestamp. In an embodiment, the video processor is configured to perform real-time motion analysis on the video frames. In an embodiment, the system comprises an artificial intelligence configuration.

In an illustrative aspect, a method for diagnosing a disorder in an animal is provided. The method comprises the step of using an augmented visual assessment system in diagnosis of the disorder in the animal. Any of the described augmented visual assessment systems of the present disclosure can be utilized for the method.

In an embodiment, the disorder is lameness. In an embodiment, the disorder is abnormal joint position of the animal. In an embodiment, the disorder is abnormal gait of the animal. In an embodiment, the disorder is a gait-related disorder of the animal.

In an embodiment, the method is performed in the field.

In an embodiment, the animal is a member of the Equidae family. In an embodiment, the animal is an equine. In an embodiment, the animal is a horse. In an embodiment, the animal is a donkey. In an embodiment, the animal is a zebra.

In an embodiment, the animal is a bovine. In an embodiment, the animal is a beef cattle. In an embodiment, the animal is a dairy cattle.

In an embodiment, the animal is a porcine.

### Example 1

AVA functions by autonomous detection and tracking of key body points as the animal moves through a gait cycle. Direct software recognition of reference points is not currently available for animals. Testing with applied markers to identify reference points predictive of normal and abnormal gait can provide software capable of directly identifying normal and abnormal gait.

For example, AVA can track the movement of the hip, poll and limbs calculating displacement, distances, angles and graph relevant data. Video capture can maintain centimeter accuracy as the horse moves at 3.5 m through a 30 m trial. Motorized lenses with enough focal length to close on a moving target at 30 meters with control feedback are typically expensive and tailored for a specific application. To reduce costs during development, AVA can utilize an existing motorized lens with an external high-precision absolute encoder to provide the necessary feedback in order to increase AVA's compatibility with most off-the-shelf cameras. The position estimation algorithm can consider the focal length to properly estimate marker positions at different distances. Additionally, maintaining a moving target in focus is challenging, especially if it is moving directly toward or away from the camera. To account for this, AVA can utilize parfocal lenses to minimize image quality degradation.

### Example 2

Augment Visual Assessment (AVA) provides an innovative and global approach to objective evaluation of movement complimenting the veterinarian's current subjective use of visual evaluation techniques. The system provides precision observation and temporal comparison while maintaining the ease and time efficiency needed for evaluations to take place. AVA combines advanced mechanics, optics, computer vision and artificial intelligence (AI) techniques to accurately identify, track, quantify and record gait deficits. The system comprises an auto-zoom software and hardware to maintain the animal's image at a constant scale on the screen, giving a view as if the animal is moving on a treadmill, thus ensuring consistency in the evaluation.

Further, advanced video components can track movement of specific anatomical structures and utilize algorithms to evaluate vertical displacements, velocities, acceleration, position and joint angles. Data recorded from virtual body markers and uploaded to AVA computing software via an internet connection can provide objective data (metrics) that enhance visual evaluation and provide temporal comparison of examinations. Further, AVA can comprise features such as contrast/brightness adjustment, slow motion, side-by-side analysis, video medical libraries, and time stamped record of medical/digital notes.

Unlike other available alternatives, AVA uses two cameras with a motorized zoom resulting in position estimation having centimeter accuracy up to 30 m. This system greatly reduces the overall system footprint, cost and complexity, making it a viable marketable solution. Further, AVA utilizes a system of neural networks trained to support real-time marker detection, dynamic skeletal analysis and lameness analysis.

Resolution and marker tracking assessment with a commercial high accuracy 8-camera motion capture system can be used as a standard for comparison of the system of the present disclosure.

The minimum hardware and software requirements of the AVA system indicate that a single camera fitted with a parfocal lens with 4-250 mm of focal length is preferred and that a minimum resolution of 640×480 pixels is needed to process the images with sufficient precision. Further, a higher resolution sensor (720/1080p) can be used based on the camera video transmission rates.

Moreover, video acquisition experiments have been performed at different frame rates in order to define the minimum video requirements to analyze subtle motions on a moving target. These results indicate that at least 60 fps are required to accompish acceptable slow-motion performance. However, 120 fps can increase compatibility with other species and applications.

### Example 3

AVA can provide high accuracy measurements up to 30 m in order to assist professionals to achieve more consistent, measurable and objective results for visual assessment. For instance, veterinarians typically subjectively analyze the motion of specific reference points located on the horse's head and pelvis. The motion of these reference points can be linked to the impact and departure phases of the gait to provide an indication of gait symmetry and assessment of lameness. Lameness of the horses' front limbs can be categorized into four levels based on the vertical asymmetry of these reference points during a straight-line trotting event where a deviation under 10 mm is considered normal and a 40 mm is considered severe and dangerous.

AVA can automatically track the displacements of these reference points using computer vision and AI techniques. It can automatically plot and classify the measured displacements into these categories. AVA only requires a small footprint, is less invasive, is economically feasible and provides accurate position estimates at centimeter increments.

The system works by visually tracking and estimating the Three-Dimensional position of key body parts on a moving animal and additional body features can be tracked to determine gait phase and accurate joint positions. These data are combined and used to analyze gait symmetry and lameness in real time.

Feature position tracking is supplemented with additional high-speed high-resolution video of the moving animal. AVA comprises two gimbal-stabilized cameras combined with a small video processor. Both cameras are rigidly attached to each other and mounted on the same gimbal and tripod in order to move together.

Each camera uses a motorized computer-controlled parfocal lens enabling auto-zooming capabilities. AVA comprises a first camera for feature tracking and position estimation. The second camera is used to record redundant and unaltered raw high speed color video for the purpose of post-processing/analysis. The cameras use a global shutter and can be externally triggered and synchronized by the video processor. The video processor receives video frames from both cameras at over 100 fps, synchronizes them using high-resolution timestamps and performs real-time motion analysis on the video frames. Raw and augmented video, as well as analysis results are presented to the user through a mobile application (app) that can be installed on a mobile device such as a cellular phone or a tablet.

To compute accurate 3D position estimates of key body parts on the subject, AVA performs a two-stage estimation analysis. In the first stage, an initial position estimate is performed by utilizing geometric position analysis and basic image filters. The second stage utilizes a neural network to refine and confirm feature tracking results and discard false positives. To calculate the feature position, its geometric properties (shape, size, color, edges, blobs) and the camera properties (intrinsic and zoom) are considered.

AVA can use artificial retro-reflective disposable marker stickers for feature tracking and position estimation making it less invasive on the horse or a completely marker-less feature tracking system based on Scale-Invariant Feature Transforms (SIFT) supported by the same neural network system.

The motorized zoom allows AVA to maintain estimation accuracy over longer distances. Estimated marker positions are refined and confirmed by a neural network trained to detect features on the acquired video frames.

AVA can use YOLO v3, a high performance and well-known open-source real-time object detection system. In contrast to other classifier-based approaches, YOLO uses a single neural net applied to the full image making it extremely fast and suitable for real-time applications. It divides the images into regions and predicts the position and probabilities for each marker (or combinations of) in each region. These predictions are used to refine the initial estimate accuracy and reduce false positives. The comparison process comprises associating the results, measuring the residual error and applying a correction factor. Markers with large residual errors or without successful associations are discarded as false positives. By utilizing this two-stage approach AVA is capable of tracking multiple markers simultaneously if they are uniquely identifiable by their size, shape, color and relative position.

The position estimation camera requires only a one-time intrinsic “factory calibration”. It is initially fitted with an infrared (IR) 850 nm band-pass filter to provide passive noise filtering. The camera can be fitted with an IR illuminator to ensure that markers are easily tracked throughout the entire detection range.

Band-pass filtering passively eliminates most of the image noise reducing the amount of software filtering required and enabling the position estimation algorithm to operate at faster rates (100-200 Hz). It also allows the system to operate and achieve more consistent results throughout differing outdoor lighting conditions. Similar techniques have been previously used to achieve robotic localization in indoor environments utilizing fiducial and IR markers.

AVA provides a similar approach, but instead uses a single camera for long range tracking while supporting the estimation process with AI techniques. To improve range and reliability over longer distances the cameras are fitted with motorized parfocal lenses (4-250 mm) that are actively controlled by AVA. This allows AVA to automatically zoom into the moving horse maintaining good visibility and measurement accuracy on the markers. The position estimation algorithm can use the focal distance at all times and can utilize active LED markers also operating in the 850 nm wavelength.

### Example 4

AVA also provides high-speed and high-resolution video acquisition, which is essential for veterinarians to visually detect gait characteristics that are related to measured positions. This feature can help veterinarians understand how specific measured gait anomalies translate into visually observable motions that are indicative of lameness through side-by-side comparisons of measured data and recorded videos.

As the position estimation camera can be filtered to only sense around 850 nm, a second camera can be used to capture full-color high-speed and high-resolution imagery. Even though the animal moves in a straight line, the cameras require tracking in three spatial dimensions. The cameras are rigidly attached to each other and mounted to a custom 3 axis motorized gimbal. Both cameras can be fitted with the same motorized zoom lens. In this manner, the video acquisition and marker position estimation is automatically centered on the horse at all times. AVA utilizes the 3D position estimate from features to maintain the camera aim at the horse by actively controlling the motorized gimbal and zoom. High-speed/high-resolution video acquisition is extremely innovative for the veterinarian who can always be able to observe the gait characteristics in slow motion

### Example 5

AVA introduces numerous autonomous video diagnostic tools to help analyze gait and lameness. Additional technologies are incorporated to augment the diagnostic method of direct examination, observation, subjective evaluation and examiner notes. Some of the tools include video playback, speed control, frame brightness, contrast and color manipulation, frame annotations and augmented reality (AR) visualizations.

AVA provides the veterinarian with a fine control of the captured video allowing the video to be paused, resumed, played or rewound at any speed. AVA can overlay tracking and analysis results onto high-resolution video utilizing AR techniques such as image, graphic or text overlays; offering a simple and intuitive mechanism to convey information to the user. For example, AVA can merge graphical and visual results to highlight the vertical displacement of the tracked pelvis and head features allowing the veterinarian to observe and evaluate the gait symmetry and lameness implication.

AVA displays motion estimation data on multiple graphs together with video data, side-by-side or combined, into a single image overlay. Frame brightness, contrast and color manipulation can be enabled at the frame level allowing the user to highlight motion in different ways.

Another useful tool is video annotation that allows the user to manually highlight areas of the image, adding written or audio comments to the frames enabling better collaboration between veterinarians. All these tools can introduce visualization flexibility and enhance collaboration which helps stakeholders (e.g. veterinarian, race track officials, horse owners etc.) to visually understand the severity of the lameness or gait-related problems over time.

All information acquired by the AVA system (raw motion estimation, video and augmented analysis results) can be stored as layers in order to keep unaltered raw data for future reference and analysis as additional tools are deployed. Additionally, the user may create modified instances of existing layers by utilizing any of the video tools on the acquired data. All data can be automatically stored in an easily accessible online database to aid future diagnosticians by providing key historical gait and lameness information of a horse over its lifetime; opening the door to diagnosis of secondary or long-term gait-related diseases and impairments

### Example 6

AVA can comprise two neural networks to support gait analysis. The first network utilizes motion tracking data to calculate the position and orientation of occluded joints by performing predictions supported by other visually detected joints, joint limits and skeletal/joint relationships. In this manner, the neural network accurately predicts the pose of most of the skeletal structure using only a few visible key joints. For example, as a horse trots towards or away from the camera, in most cases partial visual detection of 2-3 legs is only possible. However, the described AI-powered approach can accurately infer the rest of the occluded joints and use this information for further gait analysis. These predictions are combined with measured data to recreate an accurate and complete dynamic skeletal pose in every frame. The YOLO-based neural network is supported with a set of kinematic joint limits specific to the species being tracked.

The second neural network allows AVA to act as an expert system supporting the veterinarian by considering well-documented cases of gait-related illnesses and making similar predictions or flag detected anomalies on observed patients. For example, knowing the gait phase is key to determine any gait asymmetries that could indicate lameness problems. AVA uses the resulting measured and inferred data to make higher level predictions on specific gait-related diseases and defects by analyzing and detecting specific motion patterns on joints during the different gait phases. Currently, this process is rarely performed as it is time consuming and requires expertise, making it quite expensive and unpractical. AVA can be trained on well-documented and confirmed lameness cases to help predict similar illnesses on new patients. It can automatically identify suspicious gait asymmetries and predict lameness problems based on the observed motions. This dramatically reduces the required time and cost by helping the veterinarian make data-driven decisions.

Additionally, AVA automatically combines the measured vertical displacement data from the horse head and pelvis with measured and inferred knee joint positions to determine the amount of actual lameness on the horse ranging from 0 to +40 mm of average vertical displacement. In addition, joint angle estimation can provide gait phase determination during recorded motion.

Gait phase and marker position data can be used to determine the quality of the measurements prior to the analysis. For example, if the horse is not calm, this can result in frequent head swaying, non-uniform gait and curvaceous trotting that could negatively bias the analysis. For this reason, AVA can first display the gathered data (motion estimation and video) to the end user before proceeding with the analysis allowing an experienced veterinarian to choose to continue, discard all or portions of data from that trial.

What is claimed is:

1. A method for diagnosing a disorder in an animal, said method comprising the step of using an augmented visual assessment system comprising a first camera and a neural network system wherein the system is configured for motion capture of an animal in diagnosis of the disorder in the animal.

2. The method of claim 1, wherein the disorder is lameness.

3. The method of claim 1, wherein the disorder is abnormal joint position of the animal.

4. The method of claim 1, wherein the disorder is abnormal gait of the animal.

5. The method of claim 1, wherein the disorder is a gait-related disorder of the animal.

6. The method of claim 1, wherein the method is performed in the field.

7. The method of claim 1, wherein the animal is a member of the Equidae family.

8. The method of claim 1, wherein the method is performed on a mobile device.

9. The method of claim 1, wherein the first camera comprises a parfocal lens of at least a 4-250 mm focal length.

10. The method of claim 1, wherein the second camera comprises a motorized parfocal lens.

11. The method of claim 1, wherein the system captures slow-motion performance of the animal.

12. The method of claim 1, wherein the system captures video at 60 frames or greater per second.

13. The method of claim 1, wherein the system captures video at 120 frames or greater per second.

14. The method of claim 1, wherein the system comprises a steady automatic zoom feature.

15. The method of claim 1, wherein the method comprises detection of one or more body parts of the animal, wherein the animal is performing a gait cycle.

16. The method of claim 15, wherein the one or more body parts are selected from the group consisting of hip, poll, limb, torso, and any combination thereof.

17. The method of claim 1, wherein the method comprises tracking of one or more body parts of the animal, wherein the animal is performing a gait cycle

18. The method of claim 1, wherein the method comprises quantifying the detection of one or more body parts of the animal, quantifying the tracking of one or more body parts of the animal, wherein the animal is performing a gait cycle, or both.

19. The method of claim 1, wherein the method comprises recording the detection of one or more body parts of the animal, recording the tracking of one or more body parts of the animal, wherein the animal is performing a gait cycle, or both.

20. The method of claim 1, wherein the method evaluates one or more of vertical displacement, velocity, acceleration, position, and joint angle of the animal.
